(19) United States
(12) Patent Application Publication
(10) Pub. No.: US 2026/0353442 A1
(43) Pub. Date: Nov. 5, 2026

(54) SYSTEMS, METHODS, AND DEVICES FOR UNLICENSED SIDELINK PRIORITY TO ACCESS CLASS MAPPING

(71) Applicant: Apple Inc., Cupertino, CA (US)

(72) Inventors: Huaning Niu, San Jose, CA (US); Chunxuan Ye, San Diego, CA (US); Wei Zeng, Saratoga, CA (US); Dawei Zhang, Saratoga, CA (US); Haitong Sun, Saratoga, CA (US); Peng Cheng, Beijing (CN); Zhibin Wu, Los Altos, CA (US); Weidong Yang, San Diego, CA (US); Ankit Bhamri, Haar (DE)

(21) Appl. No.: 19/101,917

(22) PCT Filed: Aug. 12, 2022
(86) PCT No.: PCT/CN2022/112329

§ 371 Date: Feb. 7, 2025

(51) Int. Cl. H04W 74/0808; H04W 92/18

(52) U.S. Cl. CPC H04W 74/0808; H04W 92/18

(57) ABSTRACT

The techniques described herein provide solutions for enabling sidelink (SL) unlicensed band or spectrum (SL-U) communications with quality and priority standards. A PC5 quality of service (QoS) identifier (PQI) value may be configured and used to indicate a QoS associated with an SL-U communication (e.g., a channel, data flow, etc.). Similarly, a layer 1(L1 ) priority indicator may be configured and used to indicate a priority of an SL-U transmission or SL channel. The PQI and/or L1 priority indicator may be mapped to a channel access priority class (CAPC) value, and the PQI, L1 priority, and/or CAPC values may indicate SL COT sharing, maximum COT, timing gaps for COT sharing, listen-before-talk (LBT) configuration, traffic and channel priorities, and more.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) to communicate with one another directly.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of an example process for determining and using channel access priority class (CAPC) for unlicensed sidelink (SL-U) according to one or more implementations described herein.

FIG. 3 is a diagram of an example for mapping between PC5 quality of service (QoS) identifier (PQI) and layer 1 (L1) priority for SL-U according to one or more implementations described herein.

FIG. 4 is a diagram of an example for a hybrid approach to L1 priority signaling in stage 1 SL control information (SCI) according to one or more implementations described herein.

FIG. 5 is a diagram of an example for determining CAPC based on L1 priority according to one or more implementations described herein.

FIG. 6 is a diagram of an example for determining CAPC by mapping PQI to 5QI based on QoS characteristics according to one or more implementations described herein.

FIG. 7 is a diagram of an example for determining CAPC by mapping PQI to packet delay budgets (PDB) according to one or more implementations described herein.

FIG. 8 is a diagram of an example for determining CAPC by mapping L1 priority to PDB according to one or more implementations described herein.

FIG. 9 is a diagram of an example for determining CAPC by mapping L1 priority to CAPC according to one or more implementations described herein.

FIG. 10 is a diagram of an example for determining CAPC and maximum channel occupancy time (MCOT) for SL-U COT sharing based on L1 priority according to one or more implementations described herein.

FIG. 11 is a diagram of an example for using CAPC during SL-U COT sharing scenarios according to one or more implementations described herein.

FIG. 12 is a diagram of an example for using L1 priorities during SL-U COT sharing scenarios according to one or more implementations described herein.

FIG. 13 is a diagram of an example for using SL-U signals/channels per CAPC according to one or more implementations described herein.

FIG. 14 is a diagram of an example process for determining a physical channel priority for transmitting SL-U communications according to one or more implementations described herein.

FIG. 15 is a diagram of an example of physical channel priority procedures related to L1 priority according to one or more implementations described herein.

FIG. 16 is a diagram of an example of control plane protocol stack in accordance with one or more implementations described herein.

FIG. 17 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless networks may include user equipment (UEs) capable of communicating with base stations, wireless routers, satellites, and other network nodes. Such devices may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). A UE may refer to a smartphone, tablet device, wearable wireless device, a vehicle capable of wireless communications and/or another type of wireless-capable device.

UEs may utilize one or more types of communication technologies to communicate directly with one another. Examples of such technologies may include proximity-based service (ProSe) or device-to-device (D2D) communications, vehicle-to-anything (V2X) communications, sidelink (SL) communications, and more. SL communications, as described herein, may include a scenario in which a UE operates to discover, establish a connection, and communicate, with one or more other UEs directly. SL communications using the unlicensed wireless spectrum may be referred to as SL-U communications.

SL-U communications may be performed using one or more wireless resources (e.g., channels, signals, carriers, etc.). The resources may be negotiated between the UEs themselves or may be based on a dynamic grant (DG) or configured grant (CG) provided to a UE by the network (e.g., scheduled by a base station). Due to the shared nature of unlicensed spectrum (e.g., with various operators, radio access technologies, users), the use of wireless resources in SL-U communications may involve various techniques to resolve channel access conflicts, such as a channel occupancy time (COT), gaps between signals in a COT sharing scenario, listen-before-talk (LBT) techniques, and more. Currently available SL-U techniques, however, fail to provide an adequate solution for SL-U communications by for example, failing to provide solutions that balance the desirability of quality and priority of transmissions over unlicensed wireless resources (e.g., channels, signals, etc.). For example, while communication standards between a UE and a base station (e.g., the Uu interface) may include features such as quality of service (QoS), 5G QoS identifier (5QI), channel access priority classes (CAPC), etc., such standards fail to provide solutions for quality and priority for SL-U communications.

The techniques described herein provide solutions for enabling SL-U communications with quality and priority requirements. The techniques described herein enable the determination and use of a PQI value for SL-U communications, which may generally refer to a QoS associated with an SL-U communication (e.g., a channel, data flow, etc.). Similarly, a layer 1 (L1) priority level or indicator may be determined and used to indicate a priority of SL-U transmissions or channels. The PQI and/or L1 priority level may be mapped, or otherwise used to determine, a CAPC value, and the PQI, L1 priority level, and/or CAPC value may be used by a UE to determine the priority for a SL-U signals, channels, or other type of communication. In some implementations, the PQI, L1 priority level, and/or CAPC value may also, or alternatively, be used to determine SL COT sharing, a maximum COT (MCOT), timing gaps for COT sharing, LBT procedures, data traffic priorities, and more. Additional features and details of these techniques are described below with reference to the Figures below.

Generally, a PC5 QoS identifier (PQI) is a metric used in core network and radio for sidelink QoS control. Standardized PQI for V2X services and proximity services are available in 3GPP specification. The service data adaptation protocol (SDAP) may map a per-flow PQI to different SL radio bearers, which may carry different SL traffic. L1-priority may be signaled in L1 SL control information (SCI) (e.g., the physical (PHY) layer) and may function as a QoS mapping indicator for CAPC and other features of SL-U communications. For example, L1-priority may facilitate appropriate priority and resource allocations to data traffic that may vary from being more time sensitive (e.g., voice calls, streaming video, etc.) to less time sensitive (e.g., best-effort or background services). L1 priority may also be used in physical layer SL communications (e.g., via the PC5 interface between UEs). L1 priority may be used in resource selection, pre-exemption, and re-evaluation. L1 priority may also be used in determining a number of transport block (TB) retransmission of a CG, a priority of physical SL feedback channel (PSFCH) transmissions, a priority of physical uplink control channel (PUCCH) transmissions carrying SL hybrid automatic repeat request (HARQ) report information, and a priority of SL-U transmissions.

CAPC may define different classes of transmissions based on priority of the transmissions for channel access. The CAPC classes may be associated with communication conditions or parameters that may include a maximum number of transmission attempts for the priority class, a minimal contention window size for the priority class, a maximum contention window size for the priority class, an MCOT for the priority class, etc. A CAPC with a lower number or value (as compared to one with a higher number) may enable a UE to have a higher chance of acquiring a particular channel because, for example, the contention window (CW) may have a shorter duration. For example, using CAPC priority 1 may have a higher likelihood of grabbing a particular channel compared to CAPC priority 3. However, using a CAPC with a low number may cause the UE to use the channel for a shorter period of time before it needs to give another UE a chance to use the channel.

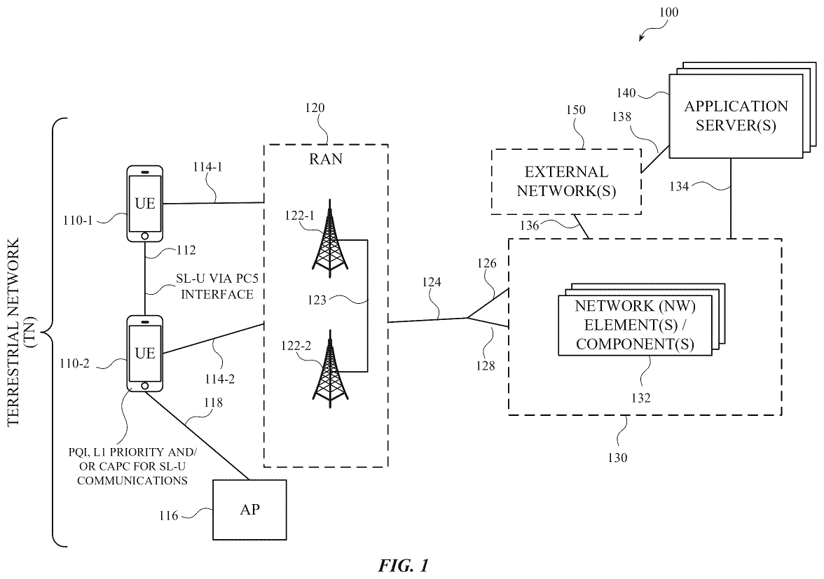

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, and external networks 150.

The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IOT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with one or more other UEs 110 via one or more wireless channels 112, each of which may comprise a physical communications interface/layer. The connection may include an M2M connection, MTC connection, D2D connection, SL connection, etc. The connection may involve a PC5 interface. In some implementations, UEs 110 may be configured to discover one another, negotiate wireless resources between one another, and establish connections between one another, without intervention or communications involving RAN node 122 or another type of network node. In some implementations, discovery, authentication, resource negotiation, registration, etc., may involve communications with RAN node 122 or another type of network node.

UEs 110 may use one or more wireless channels 112 to communicate with one another. As described herein, UE 110-1 may communicate with RAN node 122 to request SL resources. RAN node 122 may respond to the request by providing UE 110 with a dynamic grant (DG) or configured grant (CG) regarding SL resources. A DG may involve a grant based on a grant request from UE 110. A CG may involve a resource grant without a grant request and may be based on a type of service being provided (e.g., services that have strict timing or latency requirements). UE 110 may perform a clear channel assessment (CCA) procedure based on the DG or CG, select SL resources based on the CCA procedure and the DG or CG; and communicate with another UE 110 based on the SL resources. The UE 110 may communicate with RAN node 122 using a licensed frequency band and communicate with the other UE 110 using an unlicensed frequency band.

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 110, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 122.

As described herein, UE 110 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 116 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC) / physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. In an example, a licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using stand-alone unlicensed operation, licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for both UL and DL and may handle RRC and non-access stratum (NAS) related activities. The other serving cells are referred to as SCells, and each SCell may provide an individual secondary component carrier (SCC) for both UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different physical uplink shared channel (PUSCH) starting positions within a same subframe. To operate in the unlicensed spectrum, UEs 110 and the RAN nodes 122 may also operate using stand-alone unlicensed operation where the UE may be configured with a PCell, in addition to any SCells, in unlicensed spectrum.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein several CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. In NR systems, interface 123 may be an Xn interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CM 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

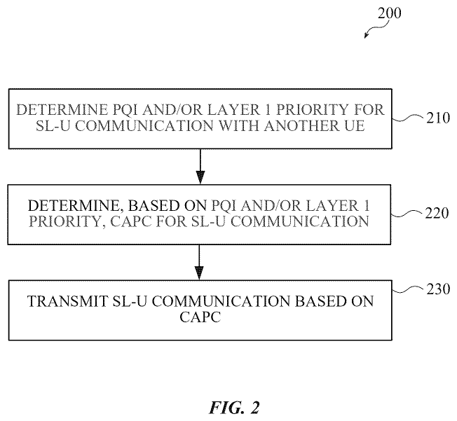

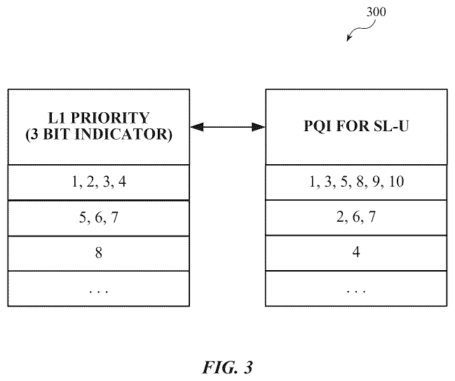

FIG. 2 is a diagram of an example process 200 for determining and using CAPC for SL-U communications according to one or more implementations described herein. Process 200 may be implemented by UE 110. In some implementations, some or all of process 200 may be performed by one or more other systems or devices, including one or more of the devices of FIG. 1. Additionally, process 200 may include one or more fewer, additional, differently ordered and/or arranged operations than those shown in FIG. 2. In some implementations, some or all of the operations of process 200 may be performed independently, successively, simultaneously, etc., of one or more of the other operations of process 200. As such, the techniques described herein are not limited to a number, sequence, arrangement, timing, etc., of the operations or process depicted in FIG. 2. FIG. 2 is described below in detail with periodic reference to FIGS. 3-13.

As shown, process 200 may include determining a PQI and/or an L1 priority indicator for SL-U communication with another UE 110 (block 210). For example, a UE 110 may determine a PQI and/or an L1 priority indicator for SL-U communication with another UE 110. As described below, a PQI and/or an L1 priority indicator may be used to map (or determine) a corresponding CPAC. As described herein, the terms map, mapping, and the like, may refer to determining one type of data, information, value, etc., based on one or more types of data, information, values, etc., that are logically associated thereto (e.g., that are related by machine-readable code, logical instructions, data structure associations, etc.). In some implementations, a PQI for SL-U communications may be determined based on a mapping of QoS characteristics of the SL-U communication and QoS characteristics of a standardized 5QI-to-QoS characteristics table for non-SL-U communications.

The PQI for the unlicensed band may be based on a standardized PQIs for V2X and/or ProSe services. The standardized PQIs for V2X and/or ProSe services may be designed for D2D communications using a licensed band (as opposed to SL-U communications). Additionally, or alternatively, the standardized PQI (e.g., a default priority) may be based on a priority value represented by a 3-bit indicator in an SL-U signal (e.g., an L1 priority), where “000” indicates a priority level of “0”, “001” indicates a priority level of “1”, and so on. The priority level may be mapped to a standardized PQI-to-QoS system used for NR PC5 for V2X or a priority value used for standardized ProSe per-packet priority (PPPP) for LTE PC5, which may each include a table of related parameters, such as PQI value, a resource type, a default priority, a packet delay budget, a packet error rate, a default maximum data burst volume, a default average window, and an example services description.

The QoS corresponding to a standardized PQI may be further mapped to a 5QI of a 5QI-to-QoS table for non-SL-U communications, and the 5QI may be mapped to a CAPC value. The standardized PQIs for V2X and/or ProSe services may correspond to CAPC value 1, which may be the highest priority CAPC. In some implementations, non-standardized PQI values may be configured by a SL service application (e.g., an application being used for the SL-U communication). In some implementations, the PQI may be determined based on a different, or additional, standardized PQI table for general services (e.g., a standardized 5QI-to-QoS characteristics mapping table). A standardized 5QI-to-QoS characteristics mapping table may include parameters including a 5QI value, a resource type, a default priority, a packet delay budget, a packet error rate, a default maximum data burst volume, a default average window, and an example services description.

The PQI may be mapped to a default L1 priority value. In some implementations, this mapping may be based on the standardized PPPP for LTE PC5 table (e.g., the standardized 5QI to QoS mapping table) discussed above. The corresponding value of the L1 priority may be found within a standardized table itself and/or via reference to another table or data structure. For instance, the L1 priority indicator may be the value of a default priority level of a corresponding PQI value of the 5QI to QoS mapping table. In some implementations, non-standardized PQI to L1 priority mapping may performed based on the SL service application being used to create the SL-U communication. In such a scenario, the SL service application may map the PQI to the L1 priority based on QoS characteristics of non-standardized PQIs.

L1 signaling may include a CAPC in the L1 SL control information (SCI). Generally, the transmission of SCI in SL communications may include a transport block with two-stage SCI, including a stage 1 SCI and stage 2 SCI. The stage 1 SCI may be transmitted over a physical sidelink control channel (PSCCH). The stage 2 SCI and the transport block can share resources of a physical sidelink shared channel (PSSCH). Since the priority of different traffic may be demined based on a CAPC priority, which may be signaled in the stage 1 SCI, stage 1 SCI may not include a 3-bit indicator of L1-priority for the SL-U communication (e.g., where “000” indicates a L1-priority of “0”, “001” indicates a L1-priority of “1”, and so on). In some implementations, signaling of CAPC instead of L1-priority can be derived implicitly based on the operating frequency band, for example if the SL signal synchronization block (S-SSB) for SL-U communications may be transmitted in the unlicensed band. In some implementations, RRC signaling may be used to indicate whether L1 SCI is to include a 3-bit priority indicator.

FIG. 3 is a diagram of an example 300 for mapping between PQI and L1 priority for SL-U communications according to one or more implementations described herein. As shown, in some implementations, L1 priority may be determined based on PQI. Additionally, or alternatively, PQI may be determined based on L1 priority. The types of data, arrangement of data, and values is provided as a non-limiting example of a default mapping between PQI and L1 priority. In some implementations, the example may include additional, alternatively, different, or alternatively arranged or associated data.

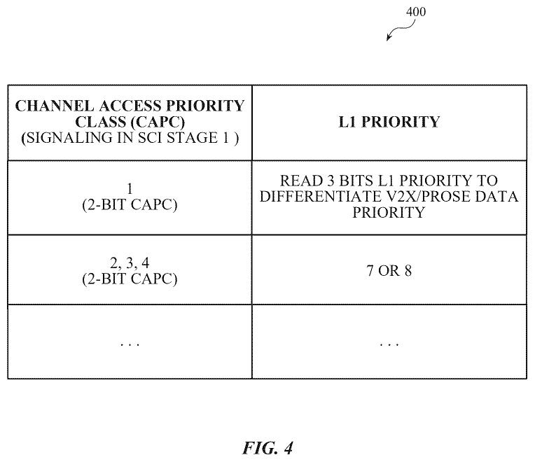

FIG. 4 is a diagram of an example 400 for a hybrid approach to L1 priority signaling in stage 1 SCI according to one or more implementations described herein. As shown, stage 1 SCI may include a 2-bit CAPC indicator, which may indicate a maximum COT (COT) and access priority. When the 2-bit CAPC indicator indicates priority 1 CAPC, an additional 3 bits of L1 priority may be used to indicate data priority. When the 2-bit CAPC indicator indicates priority 2, 3, or 4 CAPC, the L1 priority bits may be set to indicate a priority of 7 or 8, which is lower than standard V2X data priority and ProSe data priority. The types of data, arrangement of data, and values is provided as a non-limiting example of a hybrid approach to L1 priority signaling in stage 1 SCI. In some implementations, the example may include additional, alternatively, different, or alternatively arranged or associated data.

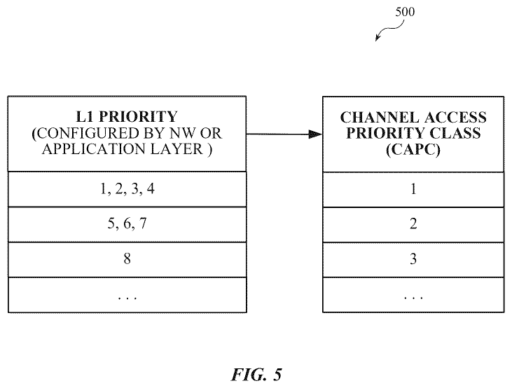

FIG. 5 is a diagram of an example 500 for determining CAPC based on L1 priority according to one or more implementations described herein. As shown, L1 priority signaling in stage 1 SCI may be configured by the network (e.g., base station 122) or an application layer (e.g., an SL service application used for the SL-U communication). In such implementations, CAPC may be determined based on the L1 priority. As such, UE 110 may determine L1 priority based on network or application layer configuration, may determine CAPC based on L1 priority. The types of data, arrangement of data, and values is provided as a non-limiting example of determining CAPC based on L1 priority. In some implementations, the example may include additional, alternatively, different, or alternatively arranged or associated data.

Referring to FIG. 2, process 200 may include determining, based on PQI and/or layer 1 priority, a CAPC for the SL-U communication (block 220). For example, UE 110 may determine, based on a PQI and/or layer 1 priority, a CAPC for the SL-U communication. In some implementations, CAPC may be used to handle real-time and non-real time communications (e.g., voice, video, best effort and background processes, etc.). UE 110 may determine CAPC by mapping PQI to CAPC. Additionally, or alternatively, UE 110 may determine CAPC by mapping L1 priority to CAPC. In some implementations, RRC signaling may be used to configure mapping between PQI and CAPC.

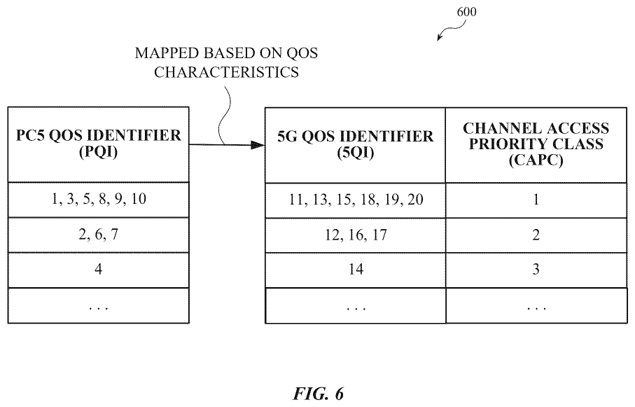

FIG. 6 is a diagram of an example 600 for determining CAPC by mapping PQI to 5QI based on QoS characteristics according to one or more implementations described herein. In some implementations, UE 110 may determine CAPC based on PQI by mapping PQI to 5QI based on QoS characteristics. Examples of the QoS characteristics, which may be used to map PQI to 5QI for SL-U purpose, may include resource type, packet delay budget, packet error rate, default max data burst volume, default averaging window and example services etc. A standardized 5QI table that relates 5QI to CAPC may then be used to determine an appropriate CAPC value for the PQI. The types of data, arrangement of data, and values is provided as a non-limiting example of determining CAPC by mapping PQI to 5QI based on QoS characteristics. In some implementations, the example may include additional, alternatively, different, or alternatively arranged or associated data.

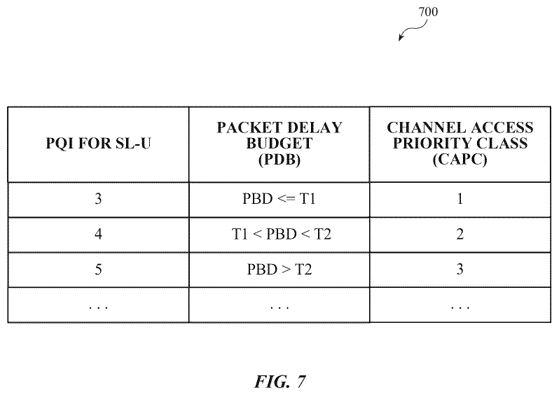

FIG. 7 is a diagram of an example 700 for determining CAPC by mapping PQI to packet delay budgets (PDB) according to one or more implementations described herein. As shown, a table or data structure may associate PQI, PDB, and CAPC, and may be used by UE 110 to determine CAPC based on PQI. For example, a PQI of 3 may correspond to a PDB of less than or equal to a first time (T1), which may in turn correspond to a CAPC value of 1. A PQI of 4 may correspond to a PDB of greater than T1 and less than or equal a second time (T2), which may in turn correspond to a CAPC value of 2. A PQI of 5 may correspond to a PDB greater than T2, which may in turn correspond to a CAPC value of 3. In some implementations, T1 may be 100 milliseconds (ms) and T2 may be 500 ms. In some implementations, T1 and/or T2 may be configured by RRC signaling. The types of data, arrangement of data, and values is provided as a non-limiting example of determining CAPC by mapping PQI to PDB. In some implementations, the example may include additional, alternatively, different, or alternatively arranged or associated data.

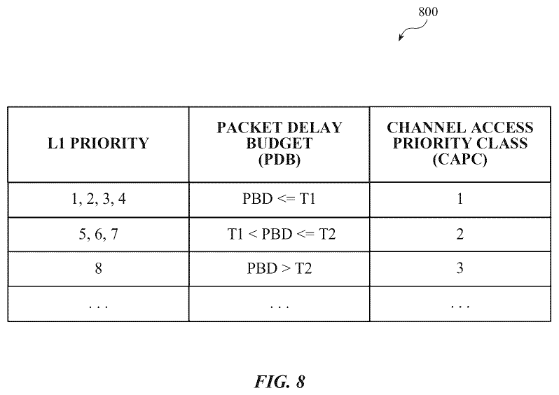

FIG. 8 is a diagram of an example 800 for determining CAPC by mapping L1 priority to PDB according to one or more implementations described herein. As shown, a table or data structure may associate L1 priority, PDB, and CAPC, and may be used by UE 110 to determine CAPC based on L1 priority. For example, a L1 priority of 1, 2, 3, or 4 may correspond to a PDB of less than or equal to a first time (T1), which may in turn correspond to a CAPC value of 1. A PQI of 5, 6, or 7 may correspond to a PDB of greater than T1 and less than or equal a second time (T2), which may in turn correspond to a CAPC value of 2. A PQI of 8 may correspond to a PDB greater than T2, which may in turn correspond to a CAPC value of 3. In some implementations, T1 may be 100 milliseconds (ms) and T2 may be 500 ms. In some implementations, T1 and/or T2 may be configured by RRC signaling. The types of data, arrangement of data, and values is provided as a non-limiting example of determining CAPC by mapping L1 priority to PDB. In some implementations, the example may include additional, alternatively, different, or alternatively arranged or associated data.

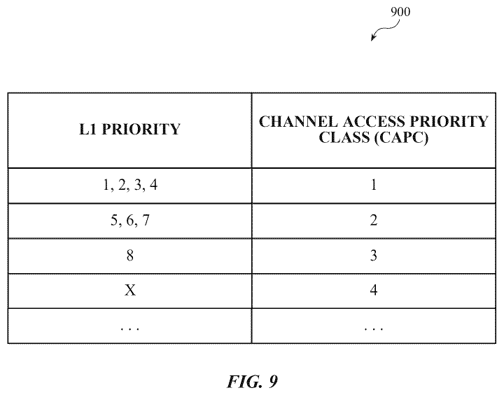

FIG. 9 is a diagram of an example 900 for determining CAPC by mapping L1 priority to CAPC according to one or more implementations described herein. For example, RRC signaling may be used to provide UE 110 with a table or data structure that logically associates L1 priority with CAPC values. UE 110 may use the table or data structure to determine an appropriate CAPC value based on an L1 priority. For instance, as shown, L1 priority 1, 2, 3, and 4 may correspond to CAPC value 1; L1 priority 5, 6, and 7 may correspond to CAPC value 2; and L1 priority 8 may correspond to CAPC value 3. CAPC value 4 may be left for an additional or alternative L1 priority value (X). The types of data, arrangement of data, and values is provided as a non-limiting example of determining CAPC by mapping L1 priority to CAPC. In some implementations, the example may include additional, alternatively, different, or alternatively arranged or associated data.

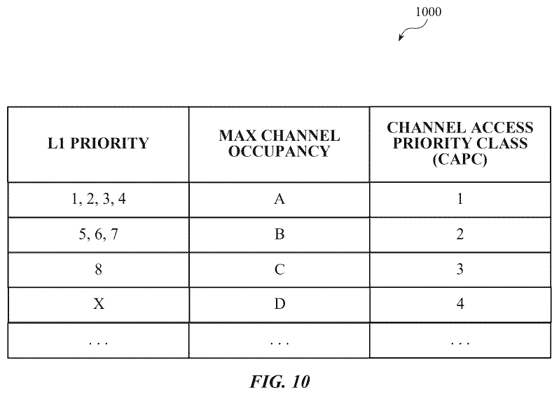

FIG. 10 is a diagram of an example 1000 for determining CAPC and MCOT for SL-U COT sharing based on L1 priority according to one or more implementations described herein. For example, UE 110 may use one or more of the 3 bits used to indicate L1 priority to also, or alternatively, determine CAPC and MCOT for SL-U COT sharing. For instance, as shown, L1 priority 1, 2, 3, and 4 may correspond to CAPC value 1 and MOC A; L1 priority 5, 6, and 7 may correspond to CAPC value 2 and MOC B; and L1 priority 8 may correspond to CAPC value 3 and MOC C. CAPC value 4 and MOC D, may be left for an additional or alternative L1 priority value (X). The types of data, arrangement of data, and values is provided as a non-limiting example of determining CAPC and MCOT for SL-U COT sharing based on L1 priority. In some implementations, the example may include additional, alternatively, different, or alternatively arranged or associated data.

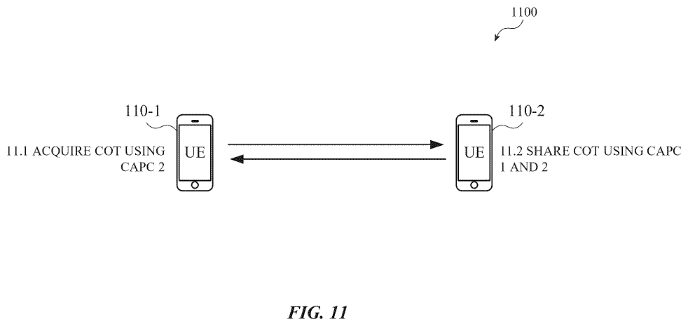

FIG. 11 is a diagram of an example 1100 for using CAPCs during SL-U COT sharing scenarios according to one or more implementations described herein. As shown, UEs 110 may communicate via SL-U COT sharing using the same CAPC or a higher level of CAPC. For example, UE 110-1 may acquire a COT (and/or an MCOT) based on a determined CAPC value of 2. UE 110-1 may have acquired the COT based on one or more of the L1 priority/CAPC techniques described herein, and UE 110-1 may signal or communicate with UE 110-2 using CAPC the value of 2 (at 11.1). UE 110-2 may receive the communication from UE 110-1, which may indicate the CAPC value of 2, and may respond via SL-U COT sharing using the same or higher CAPC (e.g., CAPC 1 or CAPC 2) (at 11.2).

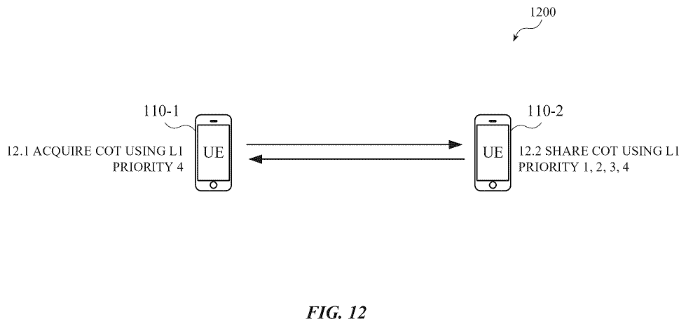

FIG. 12 is a diagram of an example 1200 for using L1 priorities during SL-U COT sharing scenarios according to one or more implementations described herein. As shown, UEs 110 may communicate via SL-U COT sharing using the same L1 priority or a higher L1 priority. For example, UE 110-1 may acquire a COT (and/or an MCOT) based on a determined L1 priority value of 4. UE 110-1 may have acquired the COT based on one or more of the L1 priority/CAPC techniques described herein, and UE 110-1 may signal or communicate with UE 110-2 using L1 priority value of 4 (at 12.1). UE 110-2 may receive the communication from UE 110-2, which may indicate the L1 priority value of 4, and may respond via SL-U COT sharing using the same or higher L1 priority (e.g., L1 priority 1, 2, 3, or 4) (at 12.2).

Referring to FIG. 2, process 200 may include transmitting an SL-U communication based upon a CAPC (block 230). For example, UE 110 may send an SL-U communication based on a CAPC. The CAPC may have been determined based on a PQI and/or L1 priority. While not shown, process 200 may also, or alternatively, include a receiving (Rx) UE 110 receiving an SL-U communication sent by a Tx UE 110. Additionally, or alternatively, the SL-U communication may include an SL-U COT shared transmission, and the Rx UE 110 may determine an appropriate CAPC and respond to the Tx UE 110 in accordance with the SL-U COT share transmission (e.g., after an appropriate gap, within a corresponding MCOT, etc.). In some implementations, the manner in which an SL-U communications are sent, received, and responded to, may be based, at least in part, on the corresponding CAPC value and CAPC category (e.g., S-SSB signal, PSFCH, etc.).

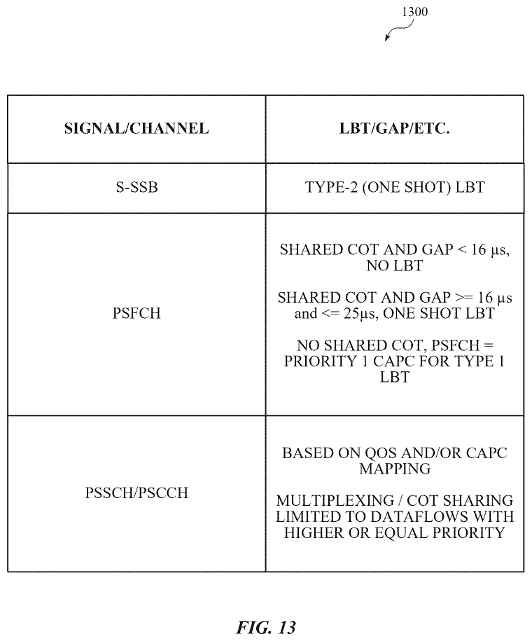

FIG. 13 is a diagram of an example 1300 for SL-U signals/channels per CAPC according to one or more implementations described herein. As shown, UE 110 may transmit an S-SSB signal after category 2 (CAT-2) or one-shot LBT. A CAT-2 LBT may include a scenario in which UE 110 the performs LBT without random backoff with a fixed-length contention window. Additionally, or alternatively, UE 110 may transmit using a PSFCH based on whether there is a shared COT and a corresponding gap length. For example, when communicating in an SL-U COT sharing scenario with a gap of less than to 16 μs, UE 110 may not perform an LBT procedure before using the PSFCH.

When communicating in an SL-U COT sharing scenario with a gap of 16 μs or 25 μs (or a gap between 16 μs and 25 μs), UE 110 may perform a CAT-2 (e.g., one shot) LBT procedure before using the PSFCH. When communicating without SL-U COT sharing, UE 110 may use a priority 1 CAPC and perform a category 1 (CAT-1) LBT before using the PSFCH. A CAT-1 LBT may include a scenario where LBT is not used, such that the UE 110 may be able to perform immediate transmissions in unlicensed bands in some exclusive cases. Additionally, or alternatively, UE 110 may transmit using a physical SL shared channel (PSSCH) and/or a physical SL control channel (PSCCH) based on a mapping between a QoS of the data to be communicated and a QoS corresponding of a corresponding CAPC. Additionally, or alternatively, when UE 110 performs a type 1 CCA procedure using a particular CAPC level, multiplexing and/or COT sharing on the PSSCH and/or PSCCH may be limited to data flows with higher or equal priorities.

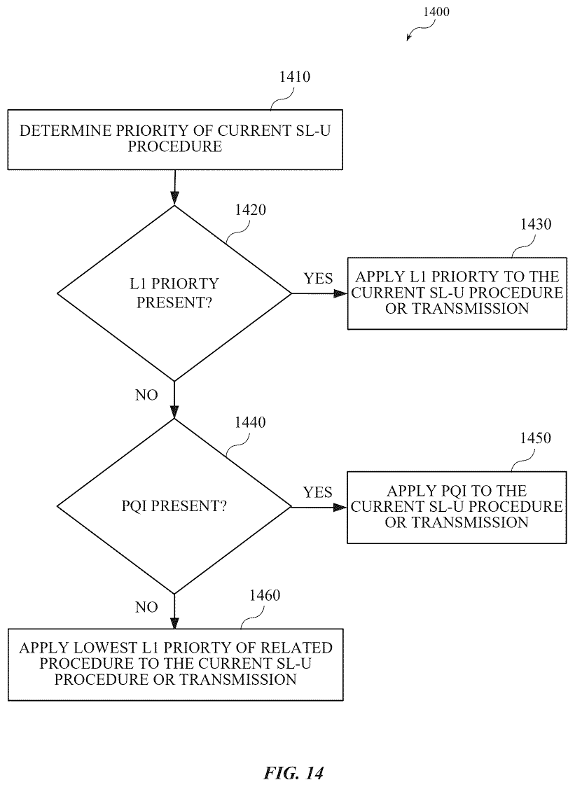

FIG. 14 is a diagram of an example process 1400 for determining a physical channel priority for transmitting SL-U communications according to one or more implementations described herein. Process 1400 may be implemented by UE 110. In some implementations, some or all of process 1400 may be performed by one or more other systems or devices, including one or more of the devices of FIG. 1. Additionally, process 1400 may include one or more fewer, additional, differently ordered and/or arranged operations than those shown in FIG. 14. In some implementations, some or all of the operations of process 1400 may be performed independently, successively, simultaneously, etc., of one or more of the other operations of process 1400. As such, the techniques described herein are not limited to a number, sequence, arrangement, timing, etc., of the operations or process depicted in FIG. 14.

As shown, process 1400 may include determining a priority of a current SL-U procedure (block 1410). For example, UE 110 may determine the priority of a current SL-U procedure being performed by UE 110. Examples of such procedures may include sending or responding to an S-SSB signal, using a PSFCH to provide feedback to a received SL transmission, or using a PSSCH or PSCCH to communicate with another UE 110. UE 110 may determine the priority of the current SL-U procedure by determining whether an L1 priority and/or PQI priority is known, or present, for the procedure. For example, a signal or message from a Tx UE 110 may include an L1 priority and/or a PQI priority, and the Rx UE 110 may determine the priority of responding to the signal or message based on the received L1 priority and/or PQI. Additionally, or alternatively, UE 110 may determine the L1 priority and/or a PQI priority for a particular procured based on a prior RRC configuration relating to the procedure.

When an L1 priority is present (block 1420—Yes), process 1400 may include applying the L1 priority to the current SL-U procedure or transmission (block 1430). For example, when the L1 priority is known, UE 110 may perform the current SL-U procedure in accordance with the L1 priority. In some implementations, this may include performing one or more of the operations, processes, or procedures, described herein, involving L1 priority or L1 priority values. When an L1 priority is not present (block 1420—No), process 1400 may include determining whether a PQI priority is present (block 1440). For example, when the priority is not present, UE 110 may determine whether a PQI priority is present.

When the PQI is present (block 1440—Yes), process 1400 may include applying the PQI to the current SL-U procedure or transmission (block 1450). For example, when the PQI of a current SL-U procedure is known, UE 110 may perform the current SL-U procedure in accordance with the PQI. In some implementations, this may include performing one or more of the operations, processes, or procedures, described herein, involving a PQI or PQI values. When the PQI is not present (block 1440—No), process 1400 may include applying a lowest L1 priority of a related procedure to the current SL-U procedure or transmission (block 1460). For example, when the PQI of a current SL-U procedure is not known, UE 110 may perform the current SL-U procedure in accordance with a lowest L1 priority of a related procedure.

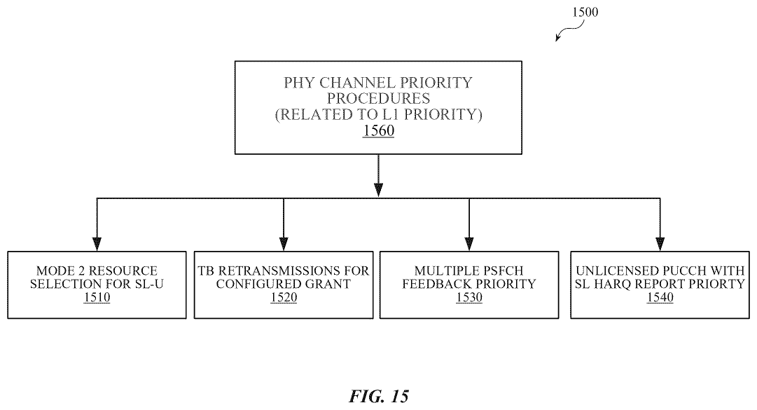

FIG. 15 is a diagram of an example 1500 of physical channel priority procedures related to L1 priority according to one or more implementations described herein. As shown, physical channel priority procedures 1560 may include mode 2 resource selection for SL-U 1510, TB retransmissions for CG 1520, multiple PSFCH feedback priority 1530, and unlicensed PUCCH with SL HARQ report priority 1540. One or more of physical channel priority procedures 1560 may be performed by UE 110 in accordance with one or more of the techniques described herein. For example, regarding mode 2 resource selection for SL-U 1510, UE 110 may perform a type 1 CCA procedure based on a corresponding CAPC. Additionally, or alternatively, when L1 priority is present or configured, UE 110 may perform resource pre-exemption and re-evaluation per the L1 priority. Regarding TB retransmissions for CG 1520, UE 110 may perform the number of retransmissions set forth by the CG. In some implementations, UE 110 may be configured to perform the same number of TB retransmissions for all CG—regardless of whether the CG specifies the number of TB retransmissions. In some implementations, UE 110 may perform the TB retransmissions according to a corresponding CAPC value per CG. Additionally, or alternatively, UE 110 may perform the TB retransmissions according to a corresponding L1 priority value per CG.

Regarding multiple PSFCH feedback priority 1530, UE 110 may provide feedback according to the CAPC value associated with providing the feedback (e.g., providing feedback data associated with a higher CAPC may be prioritized over providing feedback data associated with a lower CAPC). Additionally, or alternatively, UE 110 may provide feedback according to the L1 priority value associated with providing the feedback (e.g., providing feedback data associated with a higher L1 priority may be prioritized over providing feedback data associated with a lower L1 priority). Regarding unlicensed PUCCH with SL HARQ report priority 1540, when the PUCCH is in the unlicensed band, UE 110 may apply equal priority to each SL HARQ report. In some implementations, the SL HARQ report may instead be provided according to a corresponding CAPC (e.g., providing a SL HARQ report associated with a higher CAPC may be prioritized over providing a SL HARQ report associated with a lower CAPC). In some implementations, the SL HARQ report may also, or alternatively, be provided according to a corresponding L1 priority value (e.g., providing a SL HARQ report associated with a higher L1 priority value may be prioritized over providing a SL HARQ report associated with a lower L1 priority value).

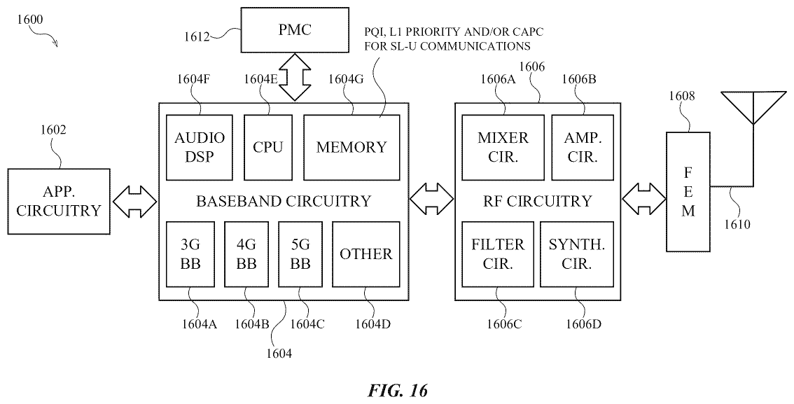

FIG. 16 is a diagram of an example of components of a device according to one or more implementations described herein. In some implementations, the device 1600 can include application circuitry 1602, baseband circuitry 1604, RF circuitry 1606, front-end module (FEM) circuitry 1608, one or more antennas 1610, and power management circuitry (PMC) 1612 coupled together at least as shown. The components of the illustrated device 1600 can be included in a UE or a RAN node. In some implementations, the device 1600 can include fewer elements (e.g., a RAN node may not utilize application circuitry 1602, and instead include a processor/controller to process IP data received from a CN or an Evolved Packet Core (EPC)). In some implementations, the device 1600 can include additional elements such as, for example, memory/storage, display, camera, sensor (including one or more temperature sensors, such as a single temperature sensor, a plurality of temperature sensors at different locations in device 1600, etc.), or input/output (I/O) interface. In other implementations, the components described below can be included in more than one device (e.g., said circuitries can be separately included in more than one device for Cloud-RAN (C-RAN) implementations).

The application circuitry 1602 can include one or more application processors. For example, the application circuitry 1602 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1600. In some implementations, processors of application circuitry 1602 can process IP data packets received from an EPC.

The baseband circuitry 1604 can include circuitry such as, but not limited to, one or more single-core or multi-core processors. The baseband circuitry 1604 can include one or more baseband processors or control logic to process baseband signals received from a receive signal path of the RF circuitry 1606 and to generate baseband signals for a transmit signal path of the RF circuitry 1606. Baseband circuity 1604 can interface with the application circuitry 1602 for generation and processing of the baseband signals and for controlling operations of the RF circuitry 1606. For example, in some implementations, the baseband circuitry 1604 can include a 3G baseband processor 1604A, a 4G baseband processor 1604B, a 5G baseband processor 1604C, or other baseband processor(s) 1604D for other existing generations, generations in development or to be developed in the future (e.g., 5G, 6G, etc.). The baseband circuitry 1604 (e.g., one or more of baseband processors 1604A-D) can handle various radio control functions that enable communication with one or more radio networks via the RF circuitry 1606. In other implementations, some or all of the functionality of baseband processors 1604A-D can be included in modules stored in the memory 1604G and executed via a Central Processing Unit (CPU) 1604E. The radio control functions can include, but are not limited to, signal modulation/demodulation, encoding/decoding, radio frequency shifting, etc. In some implementations, modulation/demodulation circuitry of the baseband circuitry 1604 can include Fast-Fourier Transform (FFT), precoding, or constellation mapping/de-mapping functionality. In some implementations, encoding/decoding circuitry of the baseband circuitry 1604 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1604G may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL COT sharing, MCOT, timing gaps for COT sharing, listen-before-talk (LBT) configuration, traffic and channel priorities, and more.

In some implementations, the baseband circuitry 1604 can include one or more audio digital signal processor(s) (DSP) 1604F. The audio DSPs 1604F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1604 and the application circuitry 1602 can be implemented together such as, for example, on a system on a chip (SOC).

In some implementations, the baseband circuitry 1604 can provide for communication compatible with one or more radio technologies. For example, in some implementations, the baseband circuitry 1604 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1604 is configured to support radio communications of more than one wireless protocol can be referred to as multi-mode baseband circuitry.

RF circuitry 1606 can enable communication with wireless networks using modulated electromagnetic radiation through a non-solid medium. In various implementations, the RF circuitry 1606 can include switches, filters, amplifiers, etc. to facilitate the communication with the wireless network. RF circuitry 1606 can include a receive signal path which can include circuitry to down-convert RF signals received from the FEM circuitry 1608 and provide baseband signals to the baseband circuitry 1604. RF circuitry 1606 can also include a transmit signal path which can include circuitry to up-convert baseband signals provided by the baseband circuitry 1604 and provide RF output signals to the FEM circuitry 1608 for transmission.

In some implementations, the receive signal path of the RF circuitry 1606 can include mixer circuitry 1606A, amplifier circuitry 1606B and filter circuitry 1606C. In some implementations, the transmit signal path of the RF circuitry 1606 can include filter circuitry 1606C and mixer circuitry 1606A. RF circuitry 1606 can also include synthesizer circuitry 1606D for synthesizing a frequency for use by the mixer circuitry 1606A of the receive signal path and the transmit signal path. In some implementations, the mixer circuitry 1606A of the receive signal path can be configured to down-convert RF signals received from the FEM circuitry 1608 based on the synthesized frequency provided by synthesizer circuitry 1606D. The amplifier circuitry 1606B can be configured to amplify the down-converted signals and the filter circuitry 1606C can be a low-pass filter (LPF) or band-pass filter (BPF) configured to remove unwanted signals from the down-converted signals to generate output baseband signals. Output baseband signals can be provided to the baseband circuitry 1604 for further processing. In some implementations, the output baseband signals can be zero-frequency baseband signals, although this is not a requirement. In some implementations, mixer circuitry 1606A of the receive signal path can comprise passive mixers, although the scope of the implementations is not limited in this respect.

In some implementations, the mixer circuitry 1606A of the transmit signal path can be configured to up-convert input baseband signals based on the synthesized frequency provided by the synthesizer circuitry 1606D to generate RF output signals for the FEM circuitry 1608. The baseband signals can be provided by the baseband circuitry 1604 and can be filtered by filter circuitry 1606C.

In some implementations, the mixer circuitry 1606A of the receive signal path and the mixer circuitry 1606A of the transmit signal path can include two or more mixers and can be arranged for quadrature down conversion and up conversion, respectively. In some implementations, the mixer circuitry 1606A of the receive signal path and the mixer circuitry 1606A of the transmit signal path can include two or more mixers and can be arranged for image rejection (e.g., Hartley image rejection). In some implementations, the mixer circuitry 1606A of the receive signal path and the mixer circuitry 1406A can be arranged for direct down conversion and direct up conversion, respectively. In some implementations, the mixer circuitry 1606A of the receive signal path and the mixer circuitry 1606A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1606 can include analog-to-digital converter (ADC) and digital-to-analog converter (DAC) circuitry and the baseband circuitry 1604 can include a digital baseband interface to communicate with the RF circuitry 1606.

In some dual-mode implementations, a separate radio IC circuitry can be provided for processing signals for each spectrum, although the scope of the implementations is not limited in this respect.

In some implementations, the synthesizer circuitry 1606D can be a fractional-N synthesizer or a fractional N/N+1 synthesizer, although the scope of the implementations is not limited in this respect as other types of frequency synthesizers can be suitable. For example, synthesizer circuitry 1606D can be a delta-sigma synthesizer, a frequency multiplier, or a synthesizer comprising a phase-locked loop with a frequency divider.

The synthesizer circuitry 1606D can be configured to synthesize an output frequency for use by the mixer circuitry 1606A of the RF circuitry 1606 based on a frequency input and a divider control input. In some implementations, the synthesizer circuitry 1606D can be a fractional N/N+1 synthesizer.

In some implementations, frequency input can be provided by a voltage-controlled oscillator (VCO), although that is not a requirement. Divider control input can be provided by either the baseband circuitry 1604 or the applications circuitry 1602 depending on the desired output frequency. In some implementations, a divider control input (e.g., N) can be determined from a look-up table based on a channel indicated by the applications circuitry 1602.

Synthesizer circuitry 1606D of the RF circuitry 1606 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1606D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1606 can include an IQ/polar converter.

FEM circuitry 1608 can include a receive signal path which can include circuitry configured to operate on RF signals received from one or more antennas 1610, amplify the received signals and provide the amplified versions of the received signals to the RF circuitry 1606 for further processing. FEM circuitry 1608 can also include a transmit signal path which can include circuitry configured to amplify signals for transmission provided by the RF circuitry 1606 for transmission by one or more of the one or more antennas 1610. In various implementations, the amplification through the transmit or receive signal paths can be done solely in the RF circuitry 1606, solely in the FEM circuitry 1608, or in both the RF circuitry 1606 and the FEM circuitry 1608.

In some implementations, the FEM circuitry 1608 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1606). The transmit signal path of the FEM circuitry 1608 can include a power amplifier (PA) to amplify input RF signals (e.g., provided by RF circuitry 1606), and one or more filters to generate RF signals for subsequent transmission (e.g., by one or more of the one or more antennas 1610).

In some implementations, the PMC 1612 can manage power provided to the baseband circuitry 1604. In particular, the PMC 1612 can control power-source selection, voltage scaling, battery charging, or DC-to-DC conversion. The PMC 1612 can often be included when the device 1600 is capable of being powered by a battery, for example, when the device is included in a UE. The PMC 1612 can increase the power conversion efficiency while providing desirable implementation size and heat dissipation characteristics.

While FIG. 16 shows the PMC 1612 coupled only with the baseband circuitry 1604. However, in other implementations, the PMC 1612 may be additionally or alternatively coupled with, and perform similar power management operations for, other components such as, but not limited to, application circuitry 1602, RF circuitry 1606, or FEM circuitry 1608.

In some implementations, the PMC 1612 can control, or otherwise be part of, various power saving mechanisms of the device 1600. For example, if the device 1600 is in an RRC_Connected state, where it is still connected to the RAN node as it expects to receive traffic shortly, then it can enter a state known as Discontinuous Reception Mode (DRX) after a period of inactivity. During this state, the device 1600 can power down for brief intervals of time and thus save power.

If there is no data traffic activity for an extended period of time, then the device 1600 can transition off to an RRC_Idle state, where it disconnects from the network and does not perform operations such as channel quality feedback, handover, etc. The device 1600 goes into a very low power state and it performs paging where again it periodically wakes up to listen to the network and then powers down again. The device 1600 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1602 and processors of the baseband circuitry 1604 can be used to execute elements of one or more instances of a protocol stack. For example, processors of the baseband circuitry 1604, alone or in combination, can be used execute Layer 3, Layer 2, or Layer 1 functionality, while processors of the baseband circuitry 1604 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

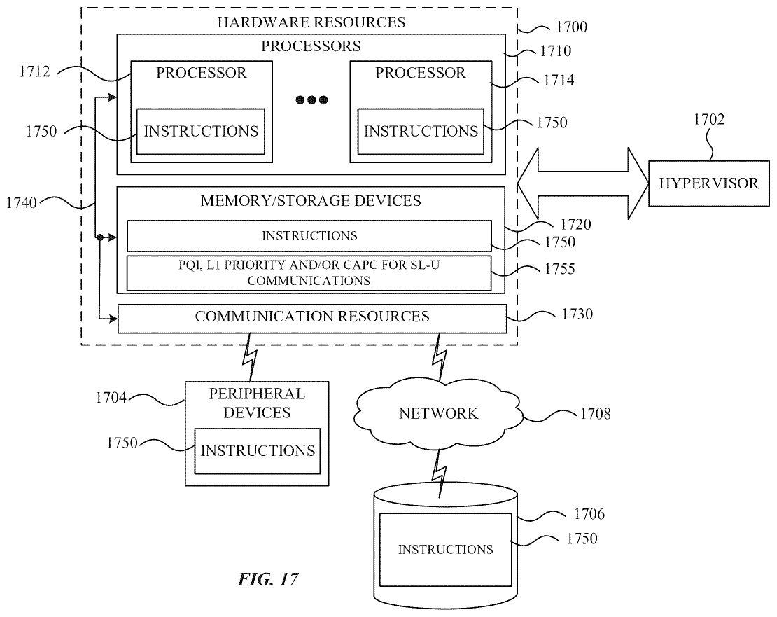

FIG. 17 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 17 shows a diagrammatic representation of hardware resources 1700 including one or more processors (or processor cores) 1710, one or more memory/storage devices 1720, and one or more communication resources 1730, each of which may be communicatively coupled via a bus 1740.

The processors 1710 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1712 and a processor 1714.

The memory/storage devices 1720 may include main memory, disk storage, or any suitable combination thereof. The memory/storage devices 1720 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1720 may receive and store one or more configurations, instructions, and/or other information 1755 for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL COT sharing, MCOT, timing gaps for COT sharing, listen-before-talk (LBT) configuration, traffic and channel priorities, and more.

The communication resources 1730 may include interconnection or network interface components or other suitable devices to communicate with one or more peripheral devices 1704 or one or more databases 1706 via a network 1708. For example, the communication resources 1730 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1750 may comprise software, a program, an application, an applet, an app, or other executable code for causing at least any of the processors 1710 to perform any one or more of the methodologies discussed herein. The instructions 1750 may reside, completely or partially, within at least one of the processors 1710 (e.g., within the processor's cache memory), the memory/storage devices 1720, or any suitable combination thereof. Furthermore, any portion of the instructions 1750 may be transferred to the hardware resources 1700 from any combination of the peripheral devices 1704 or the databases 1706. Accordingly, the memory of processors 1710, the memory/storage devices 1720, the peripheral devices 1704, and the databases 1706 are examples of computer-readable and machine-readable media.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user equipment (UE), may comprise: a memory; and one or more processors configured to, when executing instructions stored in the memory, cause the UE to: determine a PC5 quality of service (QoS) identifier (PQI) for an unlicensed spectrum sidelink (SL-U) communication; determine, based on the PQI for the SL-U communication, a channel access priority class (CAPC) value; and transmit the SL-U communication based on the CAPC value. In example 2, which may also include one or more of the examples described herein, the PQI for the SL-U communication is based on a standardized PQI for a proximity-based service (ProSe) for a licensed frequency band.

In example 3, which may also include one or more of the examples described herein, the PQI for the SL-U communication is based on a standardized PQI for a vehicle-to-anything (V2X) for a licensed frequency band. In example 4, which may also include one or more of the examples described herein, the PQI for the SL-U communication is based a layer 1 (L1) priority value. In example 5, which may also include one or more of the examples described herein, the L1 priority value is signaled in stage 1 sidelink (SL) control information (SCI).

In example 6, which may also include one or more of the examples described herein, the CAPC value is determined based on QoS characteristics of the SL-U communication and QoS characteristics of a standardized 5QI-to-QoS characteristics table for a licensed frequency band. In example 7, which may also include one or more of the examples described herein, the CAPC value is determined based a packet delay budget (PDB) associated with the PQI for the SL-U communication. In example 8, which may also include one or more of the examples described herein, the SL-U communication comprises a SL signal synchronization block (S-SSB) and the UE is to perform a type 2 listen-before-talk (LBT) procedure prior to transmitting the SL-U communication.

In example 9, which may also include one or more of the examples described herein, the SL-U communication comprises a physical SL feedback channel (PSFCH) communication and a shared channel occupancy time (COT) with a corresponding gap, and the UE is to, prior to transmitting the SL-U communication, determine an LBT procedure based on the gap. In example 10, which may also include one or more of the examples described herein, the SL-U communication comprises a physical SL shared channel (PSSCH) communication or a physical SL shared channel (PSCCH) communication, and the UE is to use a CAPC level that is equal to, or greater than, a CAPC level of a corresponding SL-U communication. In example 11, which may also include one or more of the examples described herein, the PQI for the SL-U communication is signaled by the core network or application layer.

In example 12, which may also include one or more of the examples described herein, a method, performed by a user equipment (UE), may comprise: determining a PC5 quality of service (QoS) identifier (PQI) for an unlicensed spectrum sidelink (SL-U) communication; determining, based on the PQI for the SL-U communication, a channel access priority class (CAPC) value; and transmitting the SL-U communication based on the CAPC value. In example 13, which may also include one or more of the examples described herein, a user equipment (UE), may comprise: a memory; and one or more processors configured to, when executing instructions stored in the memory, cause the UE to: determine a layer 1 (L1) priority value for an unlicensed spectrum sidelink (SL-U) communication; determine, based on the L1 priority value for the SL-U communication, a channel access priority class (CAPC) value; and transmit the SL-U communication based on the CAPC value.

In example 14, which may also include one or more of the examples described herein, the L1 priority value is used to determine the CAPC based on a PC5 quality of service (QoS) identifier (PQI) for the SL-U communication. In example 15, which may also include one or more of the examples described herein, the L1 priority value for the SL-U communication is provided via stage 1 sidelink (SL) control information (SCI). In example 16, which may also include one or more of the examples described herein, the CAPC value is determined based on a 2-bit CAPC indicator in the stage 1 SCI.

In example 17, which may also include one or more of the examples described herein, the 2-bit CAPC indicator corresponds to a maximum channel occupancy time (MCOT). In example 18, which may also include one or more of the examples described herein, an additional 3 bits of the SCI is used to indicate the L1 priority based on the CAPC value of the 2-bit CAPC indicator. In example 19, which may also include one or more of the examples described herein, the CAPC value is determined based on a packet delay budget (PDB) associated with the L1 priority.

In example 20, which may also include one or more of the examples described herein, the CAPC value is determined based on radio resource control (RRC) signaling mapping L1 priorities to CAPC values. In example 21, which may also include one or more of the examples described herein, the SL-U communication corresponds to a shared SL COT and SL-U traffic of a same or higher priority CAPC uses the shared SL COT. In example 22, which may also include one or more of the examples described herein, the SL-U communication corresponds to a shared SL COT and SL-U traffic of a same or higher L1 priority uses the shared SL COT.

In example 23, which may also include one or more of the examples described herein, the UE is to perform a type 1 clear channel assessment (CCA) procedure based the CAPC. In example 24, which may also include one or more of the examples described herein, a number of transport block (TB) retransmissions, for the SL-U communication, is based on the CAPC value or the L1 priority value. In example 25, which may also include one or more of the examples described herein, a physical sidelink (SL) feedback channel is based on the CAPC value or the L1 priority value.

In example 26, which may also include one or more of the examples described herein, a physical uplink control channel (PUCCH) information carrying SL hybrid automatic repeat request (HARQ) report information is based on the CAPC value or the L1 priority value. In example 27, which may also include one or more of the examples described herein, a method, performed by a user equipment (UE), may comprise: determining a layer 1 (L1) priority value for an unlicensed spectrum sidelink (SL-U) communication; determining, based on the L1 priority value for the SL-U communication, a channel access priority class (CAPC) value; and transmitting the SL-U communication based on the CAPC value.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1. An apparatus, comprising:
a memory; and
one or more processors, when executing instructions stored in the memory, configured to:
determine a PC5 quality of service (QoS) identifier (PQI) for a sidelink unlicensed spectrum (SL-U) communication;
determine, based on the PQI for the SL-U communication, a channel access priority class (CAPC) value; and
perform the SL-U communication based on the CAPC value.

2. The apparatus of claim 1, wherein the CAPC value is determined based on a table or data structure that associates the PQI and the CAPC value.

3. The apparatus of claim 1, wherein the PQI for the SL-U communication is based on a standardized PQI for a licensed frequency band.

4. The apparatus of claim 1, wherein the PQI for the SL-U communication is based a layer 1 (L1) priority value.

5. The apparatus of claim 4, wherein the L1 priority value is signaled in stage 1 sidelink (SL) control information (SCI).

6. The apparatus of claim 1, wherein the CAPC value is determined based on QoS characteristics of the SL-U communication and QoS characteristics of a standardized 5QI-to-QoS characteristics table for a licensed frequency band.

7. The apparatus of claim 1, wherein the CAPC value is determined based a packet delay budget (PDB) associated with the PQI for the SL-U communication.

8. The apparatus of claim 1, wherein the SL-U communication comprises a SL signal synchronization block (S-SSB) and the UE is to perform a type 2 listen-before-talk (LBT) procedure prior to transmitting the SL-U communication.

9. The apparatus of claim 1, wherein the SL-U communication comprises a physical SL feedback channel (PSFCH) communication and a shared channel occupancy time (COT) with a corresponding gap, and the UE is to, prior to transmitting the SL-U communication, determine an LBT procedure based on the gap.

10. The apparatus of claim 1, wherein the SL-U communication comprises a physical SL shared channel (PSSCH) communication or a physical SL shared channel (PSCCH) communication, and the UE is to use a CAPC level that is equal to, or greater than, a CAPC level of a corresponding SL-U communication.

11. The apparatus of claim 1, wherein the PQI for the SL-U communication is signaled by the core network or application layer.

12. A method, comprising:
determining a PC5 quality of service (QoS) identifier (PQI) for a sidelink unlicensed spectrum (SL-U) communication;
determining, based on the PQI for the SL-U communication, a channel access priority class (CAPC) value; and
transmitting the SL-U communication based on the CAPC value.

13. The method of claim 11, wherein the CAPC value is determined based on a table or data structure that associates the PQI and the CAPC value.

14. The method of claim 11, wherein the PQI for the SL-U communication is based on a standardized PQI for a licensed frequency band.

15. The method of claim 11, wherein the PQI for the SL-U communication is based a layer 1 (L1) priority value.

16. The method of claim 15, wherein the L1 priority value is signaled in stage 1 sidelink (SL) control information (SCI).

17. The method of claim 11, wherein the CAPC value is determined based on QoS characteristics of the SL-U communication and QoS characteristics of a standardized 5QI-to-QoS characteristics table for a licensed frequency band.

18. A computer-readable medium, comprising:
one or more instructions configured to cause one or more processors to:
determine a PC5 quality of service (QoS) identifier (PQI) for a sidelink unlicensed spectrum (SL-U) communication;
determine, based on the PQI for the SL-U communication, a channel access priority class (CAPC) value; and
perform the SL-U communication based on the CAPC value.

19. The computer-readable medium of claim 18, wherein the PQI for the SL-U communication is based on a standardized PQI for a proximity-based service (ProSe) for a licensed frequency band.

20. The computer-readable medium of claim 18, wherein the PQI for the SL-U communication is based on a standardized PQI for a vehicle-to-anything (V2X) for a licensed frequency band.
